(19) United States
(12) Patent Application Publication
(10) Pub. No.: US 2016/0067811 A1
(43) Pub. Date: Mar. 10, 2016

(54) CENTRAL NEGATIVE PRESSURE ARC WELDING APPARATUS AND METHOD

(71) Applicant: Beijing University of Technology, Beijing (CN)

(72) Inventors: Fan JIANG, Beijing (CN); Jianxin Wang, Beijing (CN); Shujun Chen, Beijing (CN); Shan Sheng, Beijing (CN); Jinlong Gong, Beijing (CN)

(73) Assignee: Beijing University of Technology

(21) Appl. No.: 14/865,491

(22) Filed: Sep. 25, 2015

Related U.S. Application Data
(63) Continuation of application No. PCT/CN2014/088499, filed on Oct. 13, 2014.

(30) Foreign Application Priority Data
Sep. 10, 2014 (CN) 201410458968.9
Sep. 10, 2014 (CN) 201410459304.4

(51) Int. Cl. B23K 9/26; B23K 9/167

(52) U.S. Cl. CPC B23K 9/26; B23K 9/167

(57) ABSTRACT

The present disclosure relates to a central negative pressure arc welding apparatus and method. Through a pumping gas pipeline from the suction device to hollow tubular electrode, a suction device may establish a stable, high energy density and binding arc beneath hollow tubular electrode. The binding degree, energy density and voltage of arc may be adjusted by changing the value of negative pressure in the center of arc. Accordingly, welding heat input and coefficient of weld may be precisely controlled. This apparatus may further set up central pulsating negative pressure arc by turning on valve periodically to make a periodic negative pressure in the center of arc. This present disclosure both possesses good stability and adaptability of traditional Gas Tungsten Arc Welding and achieves binding arc and good penetration of Plasma Arc Welding. Furthermore, this present disclosure improves the mechanical properties of welded joints.

### CROSS REFERENCE TO RELATED APPLICATION

This application is a continuation application of International application number PCT/CN2014/088499, filed Oct. 13, 2014, title “CENTRAL NEGATIVE PRESSURE ARC WELDING APPARATUS AND METHOD,” which claims the priority benefit of Chinese Patent Application Nos. 201410459304.4 and 201410458968.9, filed on Sep. 10, 2014, which is hereby incorporated by reference in its entirety.

### TECHNICAL FIELD

The present disclosure relates to the field of welding equipment and application technology, and more particularly to methods and devices for a central negative pressure arc welding.

### BACKGROUND

Since Swedes invented shielded metal arc welding (SMAW) and applied it to connection of the metal in 1907, welding technology has developed rapidly. As an important metal forming process, arc welding techniques have widely used in modern industrial production process such as automotive, shipbuilding, marine, aerospace and other industrial sectors. Development of various technical areas has raised higher requirements to welding process. The traditional welding processes have not met their application requirements, especially in terms of some of high-performance, large structures and new structural materials. Therefore, with the continuous development of science and technology, welding combine technology moves forward.

GTAW (TIG), as a kind of high quality welding method, has been widely used, and it has the following advantages.

Argon gas can be isolated effectively from the ambient air and it neither dissolves in the liquid metal, nor reacts with the metal. The arc can remove the surface oxide film of weld surface. Therefore, it can apply to weld a variety of metals, especially colored, easily oxidized weld metal.

TIG is the most stable arc welding method, which is very stable even though the welding current is less than 10 A and especially suitable for welding thin and ultra-thin plate. However, GTAW (TIG) itself has many shortcomings such as shallow depth of penetration, small deposition rate, low productivity and only suitable for welding thin plate which become the biggest bottleneck for this welding method. In particular, modern industry is moving in the direction of large-scale development, thick and ultra-thick plate has become increasingly widespread application. GTAW (TIG) welding can't meet such demands.

The emergence of three kind high energy density welding heat source: plasma arc welding, laser welding and electron beam welding meets new requirements to some extent, especially thick and ultra-thick plate, which have been the rapid development and application in the field of welding. Emergence of high-energy beam welding technique fills the vacancy of traditional welding techniques. High energy density welding method not only achieves one-pass penetration of thick plates, but also improves the quality of welding and welding efficiency to achieve a high quality and efficient welding.

However, welding equipment of laser welding and electron beam welding is expensive and they have high equipment operating costs and strict requirements for the joint assembly because of small beam diameter. In spite of lower energy density and larger key-hole than these two welding methods, plasma arc welding has the following advantages such as larger jet velocity, lower process costs and requirements for the joint assembly. However, welding process window of plasma arc welding is narrow and difficult to control, which has higher requirements for the skill of workers.

Therefore, these three welding methods have limitations and may be mainly applied to the field of airplane, rockets, space ship and space welding.

### SUMMARY

In order to overcome the above drawbacks and deficiencies of the existing welding method and improve welding process capabilities, the present disclosure invents a new welding apparatus and method, namely Central Negative Pressure Arc Welding Apparatus and Method. This new apparatus and method possesses excellent feasibilities and adaptabilities. Not only does it possess good stability of traditional Tungsten Arc Welding, but also improves penetration of traditional Tungsten Arc Welding. In order to achieve the above objectives, the present present disclosure presents following technical solutions:

Central negative pressure arc welding apparatus may include the following items such as a welding torch containing a hollow tubular electrode and a suction device connected with the inner chamber of said hollow tubular electrode is able to make a stable negative pressure region formed in the inner chamber of the hollow tubular electrode and the arc center of the hollow tubular electrode.

The apparatus may further include a pressure release device, said suction device is connected through with said hollow tubular electrode via said pressure release device, a valve is provided in the gas pipeline from said pressure release device to said hollow tubular electrode.

The apparatus may further include pressure display device which is used to measure and display the pressure of the pressure release device, said pressure display device connects with said pressure release device.

Said welding torch is non-consumable electrode welding torch.

Central negative pressure arc welding method may include through gas pipeline from the suction device to said hollow tubular electrode, pumping said gas pipeline by said suction device to establish a stable, high energy density and binding arc beneath hollow tubular electrode.

Binding degree, energy density and voltage of arc can be adjusted and controlled by adjusting the pressure value of the center of arc and thus welding heat input and weld shape can be adjusted and controlled during the welding process.

Turn on periodicity said valve to make a periodic negative pressure in the center of arc, when it is in atmospheric state in the center of arc, the arc is free-form, when it is in negative pressure state in the center of arc, the arc is binding-form, which sets up center pulsating negative pressure arc.

The pulsation frequency of center pulsating negative pressure arc is controlled easily during the welding process.

Differing from all conventional arc welding methods, this welding apparatus and method have advantages as follows.

1) This method has good arc stability similar to Gas Tungsten Arc Welding and greater weld penetration than Gas Tungsten Arc Welding because of the binding central negative pressure arc.

2) This method not only has binding arc of high energy density similar to Plasma Arc Welding, but also has better adaptability and wider window of welding process than Plasma Arc Welding.

3) It can adjust and control degree of binding, energy density and voltage of arc by changing the value of the negative pressure in the center of the arc precisely, thus it can control the welding heat input and coefficient of weld precisely.

4) This method can agitate and oscillate the weld pool as it is central pulsating negative pressure arc, thus it can not only prevent liquid metal from forming coarse columnar dendrites and be conducive to the formation of fine equiaxed grain, but it is beneficial to gas escape from the weld pool to keep from forming the weld porosity. So this method can improve the mechanical properties of welded joints greatly.

### BRIEF DESCRIPTION OF THE DRAWINGS

FIG. 1 shows this method works before starting the valve.

FIG. 2 shows this method works after starting the valve.

FIG. 3 shows this method works at starting periodically the valve.

FIG. 4 shows the valve switches at time.

FIG. 5 shows the contrast FIG. of conventional TIG arc and central negative pressure arc.

FIG. 6 shows the macro morphology of the welded joints of the traditional TIG welding method and the central negative pressure arc welding method.

As illustrated in the Figures above, 1 represents welding power and control systems, 2 represents non-consumable electrode welding torch, 3 represents hollow tubular electrode, 4 represents work-pieces, 5 represents suction device, 6 represents the airway path A, 7 represents pressure relief device, 8 represents pressure display device, 9 represents the airway path B, 10 represents valve, 11 represents the airway path C, 12 represents connectors, 13 represents welding cable A, 14 represents welding cable B, 15 represents the arc, 16 represents the weld, 151 represents freedom arc, 152 represents binding arc.

### DETAILED DESCRIPTION OF THE PREFERRED EMBODIMENTS

### Embodiment 1

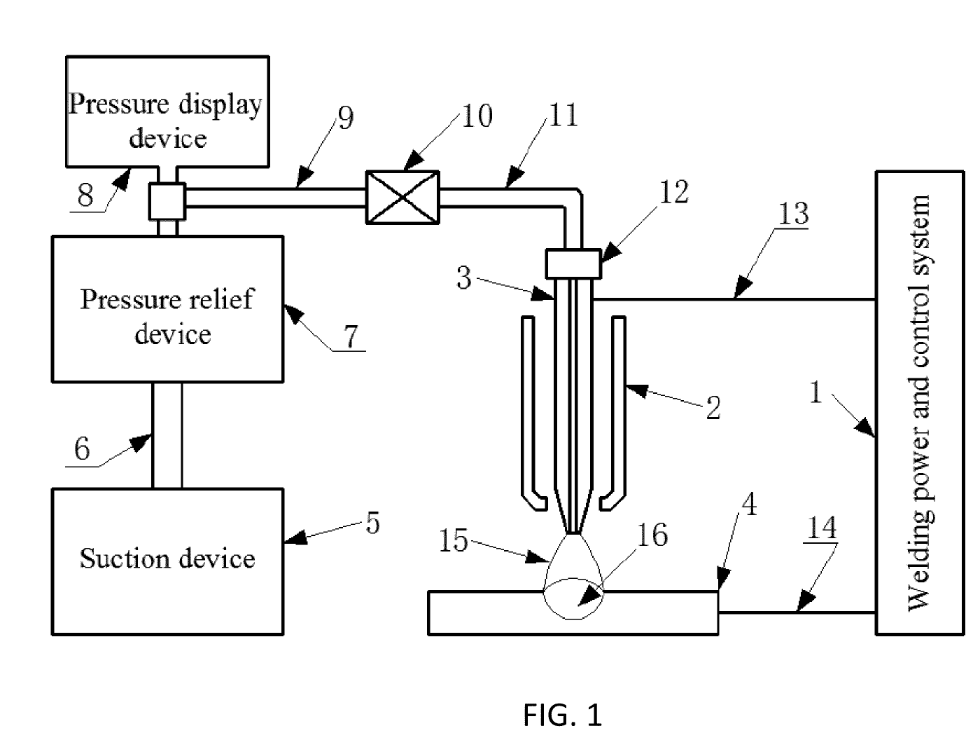

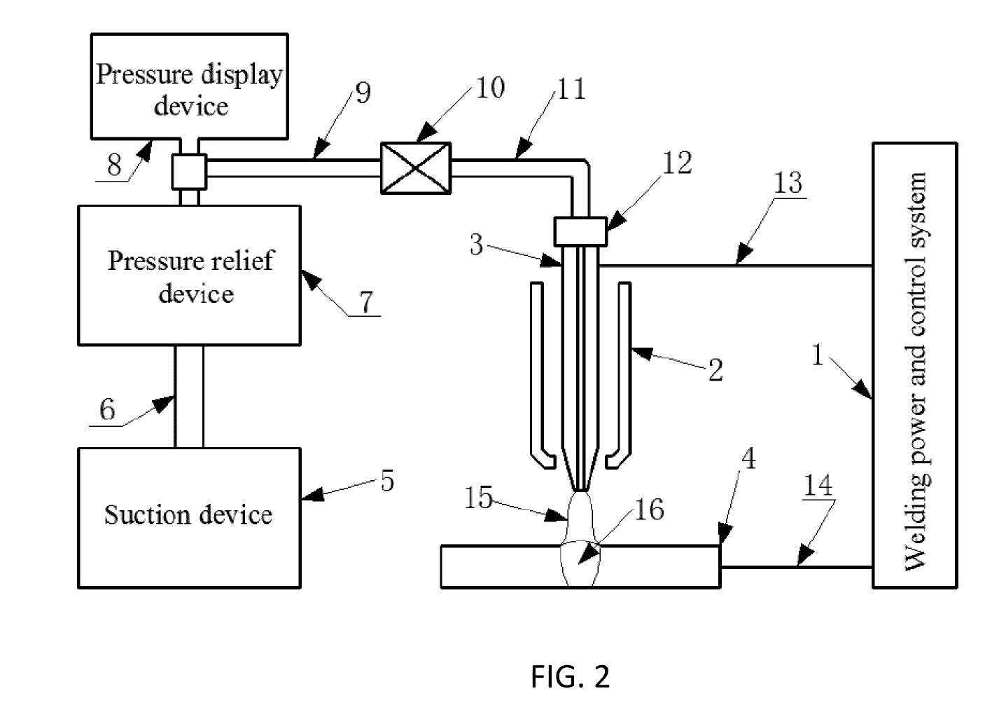

As seen in FIGS. 1 and 2, the central negative pressure arc welding apparatus mainly may include: welding power and control systems 1, non-consumable electrode welding torch 2, hollow tubular electrode 3, work-pieces 4, suction device 5, pressure relief device 7, pressure display device 8, valve 10, Among them, Suction device 5—the airway path A 6—pressure relief device 7—the airway path B 9—valve 10—the airway path C 11—connectors 12—hollow tubular electrode 3 are connected sequentially to constitute the gas passage. Pressure display device 8 which is used to measure and display the pressure value of pressure relief device 7 is connected to pressure relief device 7. Welding power supply and control system 1—welding cable B 14—work-pieces 4—non-consumable electrode welding torch 2—welding cable A 13—welding power supply and control system 1 is connected sequentially to constitute the electrical circuit, The supply of gas line and waterways which must be related to welding torch 2 apply conventional connection. Therefore they will not be described again.

Step 1: Preparations before welding: Work-pieces 4 and the welding wire matched with them are ready; Non-consumable electrode welding torch 2 is in the proper position above work-pieces 4 and the wire feed device is on same side of the welding torch 2.

Step 2: Pumping: Make sure that the gas line of suction device 5—the airway path A 6—pressure relief device 7—the airway path B 9—valve 10—the airway path C 11—connectors 12—hollow tubular electrode 3 is connected properly and then start suction device 5 to get pumping process for pressure relief device 7. Keep observing the pressure value within pressure relief device 7 until the value of pressure display device 8 reached the preset value.

Step 3: Establishing the arc: Make sure that valve 10 is being closed and then start high frequency to ignite arc. Thus freedom arc 15 is established between the hollow tubular electrode 3 and the surface of work-pieces 4 as seen in FIG. 1. Turn on the valve 10 when freedom 15 is stable, then the gas line of suction device 5—the airway path A 6—pressure relief device 7—the airway path B 9—valve 10—the airway path C 11—connectors 12—hollow tubular electrode 3 is being open, Thus, the pressure of the cavity of hollow tubular electrode 3 and the center of freedom arc 15 as seen in FIG. 1 is equal to the pressure of pressure relief device 7 which is being in negative pressure state. Thus a stable and binding central negative pressure arc 15 as seen in FIG. 2 between the hollow tubular electrode 3 and the surface of work-pieces 4 is established because of the effect of the atmospheric pressure a few seconds later.

Step 4: During the welding process: it can get independently adjusting the value of negative pressure within pressure release device 7 to change the value of negative pressure in the center of arc 15 in real-time. Thereby, it could change binding degree, voltage and energy density of arc to control and adjust welding heat input and formation coefficient of the weld precisely.

### Embodiment 2

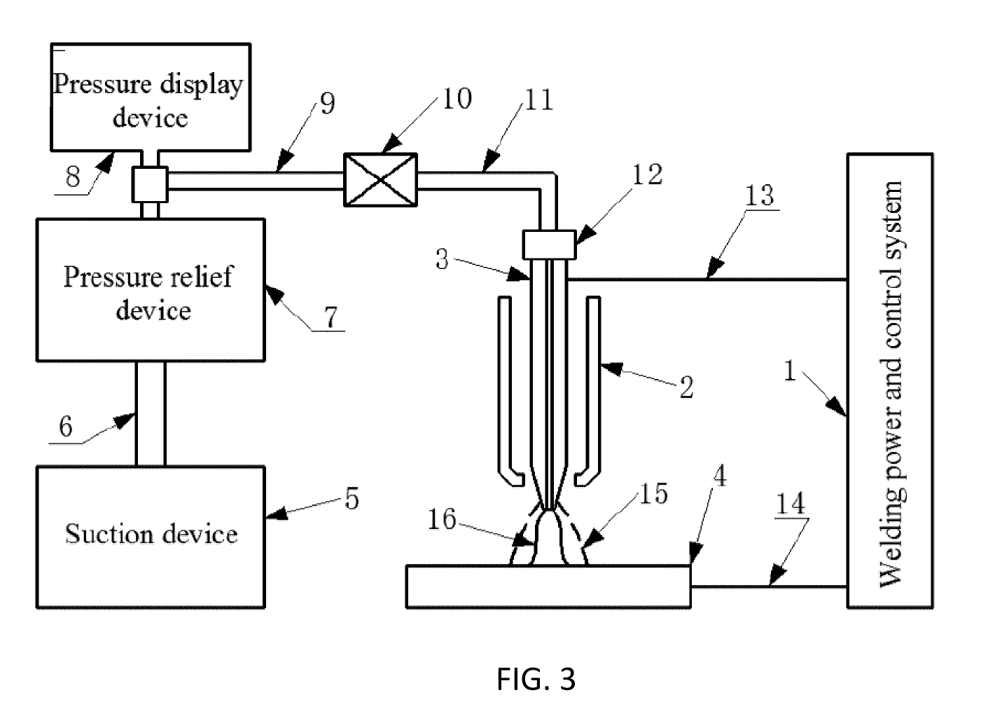

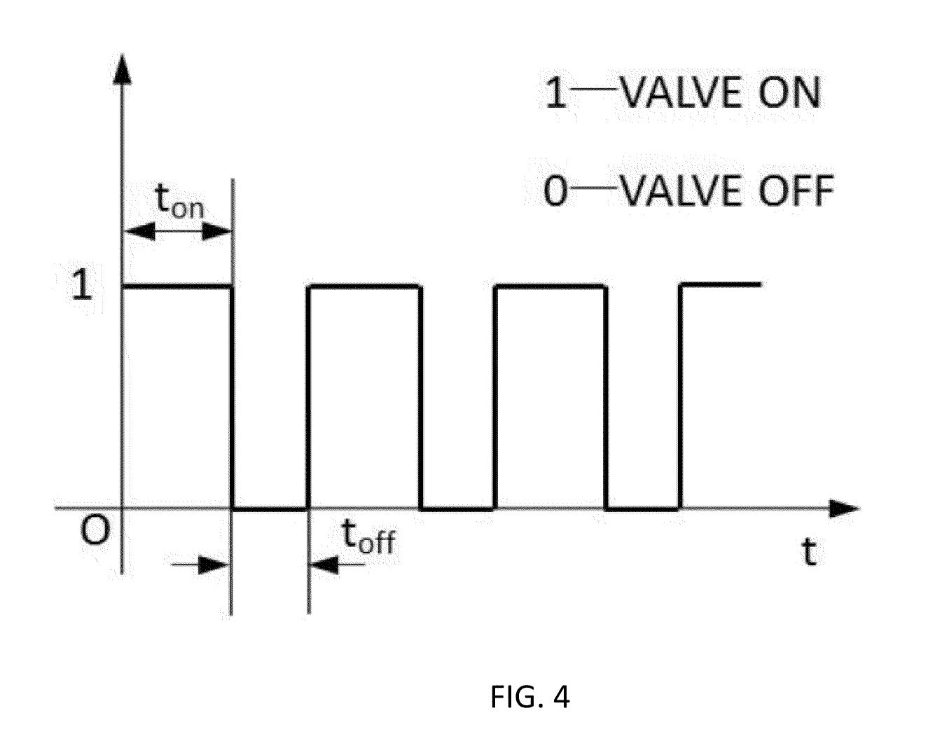

As seen in FIGS. 3 and 4, furthermore, this apparatus also sets up central pulsating negative pressure arc 15 by turning on valve 10 periodically (as seen in FIG. 4) to make a periodic negative pressure in the center of arc 15; When valve 10 is being closed, the center of the arc 15 is being in atmospheric state and the arc is free-form 151; When valve 10 is being open, the center of the arc 15 is being in negative pressure state and the arc 15 is binding-form 152. During the welding process, the pulsation frequency of center pulsating negative pressure arc 15 and the time of free-form 151 or binding-form 152 in one cycle is controlled easily by changing tₒₙ and t_{off} (namely duty ratio) as seen in FIG. 4.

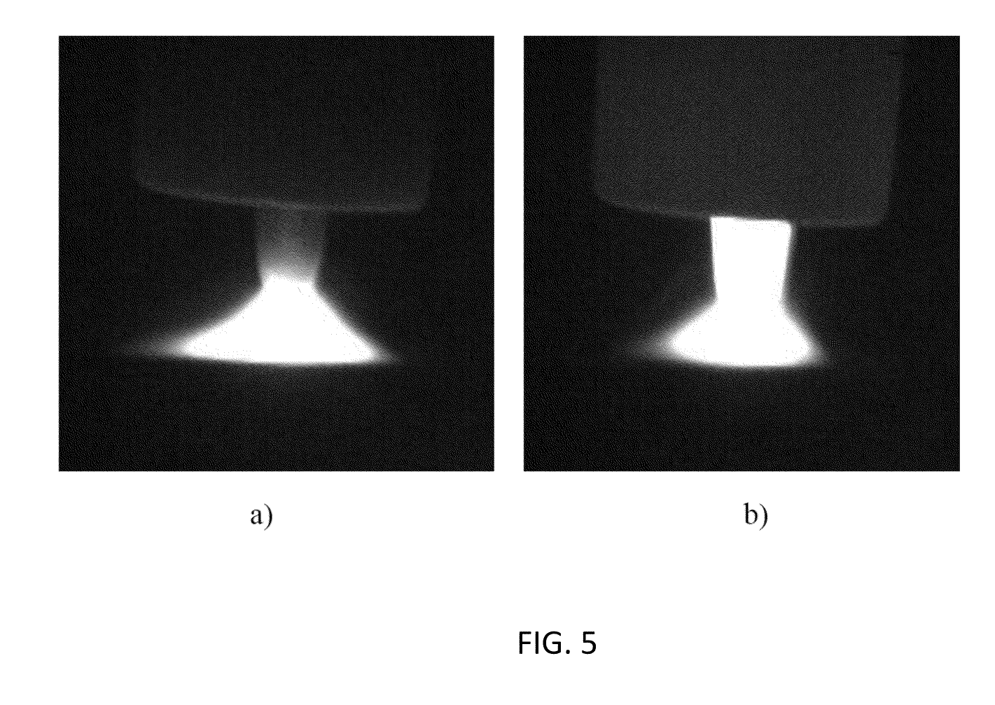

As seen in FIG. 5 shows the contrast FIG. of conventional TIG arc and central negative pressure arc with the same welding current, FIG. 5(a) shows the shape of conventional TIG arc, FIG. 5(b) shows the shape of central negative pressure arc. Compared to conventional TIG arc, column of central negative pressure arc shrinkages along the radial direction of arc, especially in the work-piece end.

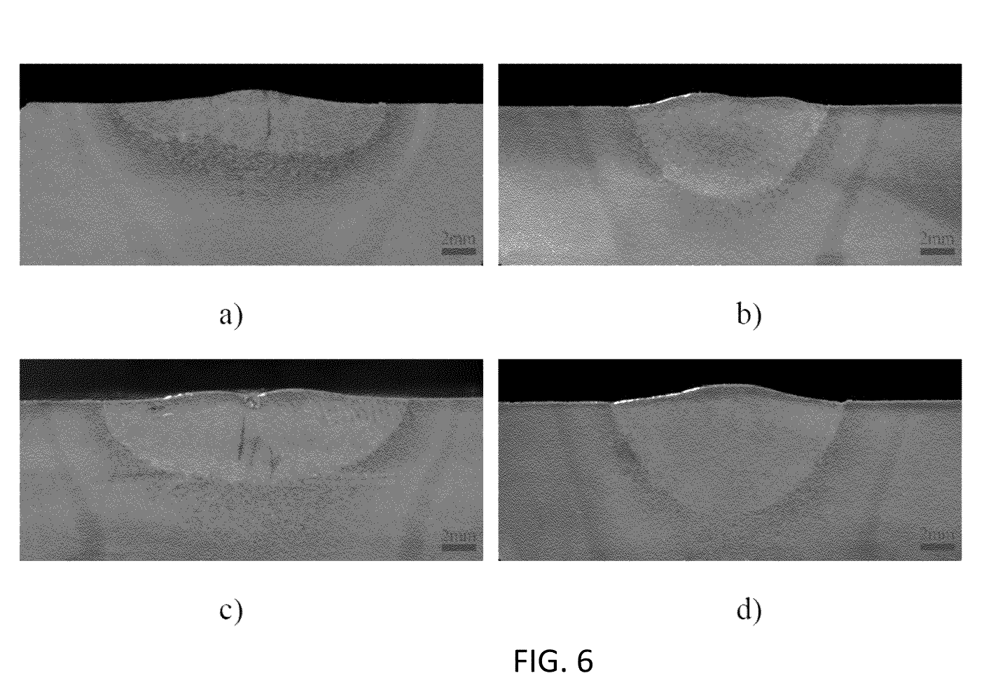

As seen in FIG. 6 shows the macro morphology of the welded joints of the traditional TIG welding method and the central negative pressure arc welding method, FIG. 6(a), Fig(b) shows the welded joint of the traditional TIG welding method and the central negative pressure arc welding method respectively when the welding current is 300 A, FIG. 6(c), Fig(d) shows the welded joint of the traditional TIG welding method and the central negative pressure arc welding method respectively when the welding current is 350 A. According to the picture, for the central negative pressure arc welding method, the weld depth is deeper, the weld width and the HAZ of welded joint is narrower. It can also be found that there exists weld crack in the center of the weld for the traditional TIG welding method. There not exists weld crack in the center of the weld for central negative pressure arc welding method.

What is claimed is:

1. A central negative pressure arc welding apparatus comprising:
a welding torch containing a hollow tubular electrode; and
a suction device connected with an inner chamber of the hollow tubular electrode such that a stable negative pressure region is formed in the inner chamber of the hollow tubular electrode and an arc center of the hollow tubular electrode.

2. The apparatus of claim 1, further comprising:
a pressure release device, wherein the suction device is connected through with the hollow tubular electrode via the pressure release device, and wherein a valve is provided in a gas pipeline from the pressure release device to the hollow tubular electrode.

3. The apparatus of claim 2, further comprising:
a pressure display device configured to measure and display pressure of the pressure release device, and wherein the pressure display device is connected with the pressure release device.

4. The apparatus of claim 1, wherein the welding torch is a non-consumable electrode welding torch.

5. A method for central negative pressure arc welding, the method comprising:
performing suction using a suction device in a gas pipeline between the suction device and a hollow tubular electrode;
forming a stable negative pressure region after establishment of an arc beneath the hollow tubular electrode; and
establishing a stable and high energy density and binding arc by using compression effect of an atmospheric pressure.

6. The method of claim 5, wherein binding degree, energy density and voltage of arc are adjustable by changing a pressure value of a center of the arc such that welding heat input and weld shapes are adjustable during a welding process.

7. The method of claim 6, further comprising:
turning on a valve periodically to make a periodic negative pressure in the center of the arc such that:
the arc is free-form in an atmospheric state in the center of the arc, and the arc is binding-form due to the compression effect of the atmospheric pressure in a negative pressure state in the center of the arc.

8. The method of claim 7, wherein a pulsation frequency of a center pulsating negative pressure arc is controlled during the welding process.
